(19) United States
(12) Patent Application Publication
(10) Pub. No.: US 2010/0017650 A1
(43) Pub. Date: Jan. 21, 2010

(54) NON-VOLATILE MEMORY DATA STORAGE SYSTEM WITH RELIABILITY MANAGEMENT

(75) Inventors: ROGER CHIN, San Jose, CA (US); Gary Wu, Fremont, CA (US)

Correspondence Address: Tung & Associates;Suite 120, 838 W. Long Lake Road, Bloomfield Hills, MI, 48302, US

(73) Assignee: Nanostar Corporation, U.S.A

(21) Appl. No.: 12/471,430

(22) Filed: May 25, 2009

Related U.S. Application Data
(63) Continuation-in-part of application No. 12/218,949, filed on Jul. 19, 2008.
Application No. 12/218,949 is a continuation-in-part of application No. 12/271,885, filed on Nov. 15, 2008.
Application No. 12/271,885 is a continuation-in-part of application No. 12/372,028, filed on Feb. 17, 2009.

(51) Int. Cl. G06F 12/16; G06F 12/02; G06F 13/28; G06F 11/14; G06F 12/08

(52) U.S. Cl. 714/6; 711/103; 710/22; 711/114; 711/206; 711/118; 711/E12.008; 711/E12.103; 711/E12.017; 714/E11.127

(57) ABSTRACT

A non-volatile memory data storage system, comprising: a host interface for communicating with an external host; a main storage including a first plurality of flash memory devices, wherein each memory device includes a second plurality of memory blocks, and a third plurality of first stage controllers coupled to the first plurality of flash memory devices; and a second stage controller coupled to the host interface and the third plurality of first stage controller through an internal interface, the second stage controller being configured to perform RAID operation for data recovery according to at least one parity.

### CROSS REFERENCE TO RELATED APPLICATIONS

The present invention is a continuation-in-part application of U.S. Ser. No. 12/218,949, filed on Jul. 19, 2008, of U.S. Ser. No. 12/271,885, filed on Nov. 15, 2008, and of U.S. Ser. No. 12/372,028, filed on Feb. 17, 2009.

### BACKGROUND OF THE INVENTION

1. Field of the Invention

The present invention relates to a non-volatile memory (NVM) data storage system with reliability management, in particular to an NVM data storage system which includes a main storage of, e.g., solid state drive (SSD), or memory card modules, in which the reliability of the stored data is improved by utilizing distributed embedded reliability management in a two-stage control architecture. The system is preferably configured as RAID-4, RAID-5 or RAID-6 with one or more remappable spare modules, or with one or more spare blocks in each module, to further prolong the lifetime of the system.

2. Description of Related Art

Memory modules made of non-volatile memory devices, in particular solid state drives (SSD) and memory cards which include NAND Flash memory devices, have great potential to replace hard disk drives (HDD) because they have faster speed, lower power consumption, better ruggedness and no moving parts in comparison with HDD. A data storage system with such flash memory modules will become more acceptable if its reliability quality can be improved, especially if the endurance cycle issue of MLC_{xN} (N=2, 3 or 4, i.e. multi-level cell with 2 bits per cell, 3 bits per cell and 4 bits per cell) is properly addressed.

One of the major failure symptoms affecting the silicon wafer yield of NAND flash devices is the reliability issue. By providing a data storage system with better capability of handling reliability issues, it does not only improve the quality of the data storage system but can also increase the wafer yield of flash devices. The utilization rate out of each flash device wafer can be greatly increased, since the system can use flash devices that are tested out with inferior criteria.

As the process technology for manufacturing NAND flash devices keeps advancing and the die size keeps shrinking, the value of Mean-Time-Between/To-Failure (MTBF/MTTF) of the NAND-flash-based SSD system decreases and the value of Uncorrectable-Bit-Error-Rate (UBER) increases. The typical SSD UBER is usually one error for 10¹⁵ bits read.

Another aspect that affects reliability characteristics of the flash-based data storage system is write amplification. The write amplification factor (WAF) is defined as the data size written into a flash memory versus the data size from host. For a typical SSD, the write amplification factor can be 30 (i.e., 1 GB of data that are written to the flash causes 30 GB of program/erase cycles).

A data storage system with good reliability management is capable of improving MTBF and UBER and reducing WAF, while enjoys the cost reduction resulting from shrunk die size. Thus, a data storage system with good reliability management is very much desired.

### SUMMARY OF THE INVENTION

In view of the foregoing, an objective of the present invention is to provide an NVM data storage system with distributed embedded reliability management in a two stage control architecture, which is in contrast to the conventional centralized single controller structure, so that reliability management loading can be shared among the memory modules. The reliability quality of the system is thus improved.

Two important measures of reliability for flash-based data storage system are MTBF and UBER. ECC/EDC, BBM, WL and RAID schemes are able to improve the reliability of the system, and thus improve the MTBF and UBER. The present invention proposes several schemes to improve WAF and other reliability factors; such schemes include but are not limited to (a) distributed channels, (b) spare block in the same or a spare module for recovering data in a defected block, (c) cache scheme, (d) double-buffer, (e) reconfigurable RAID structure, and (f) region arrangement by different types of memory devices. In the distributed channels architecture, preferably, each channel includes a double-buffer, a DMA, a FIFO, a first stage controller and a plurality of flash devices. This distributed channel architecture will minimize the unnecessary writes into flash devices due to the independently controlled write for each channel.

To improve reliability of the data storage system, the system is configured preferably by RAID 4, RAID-5 or RAID-6 and has recovery and block repair functions with spare block/module. The once defected block is replaced by the spare block, either in the same memory module or in a spare module, with the same logical block address but remapped physical address.

More specifically, the present invention proposes an NVM data storage system comprising: a host interface for communicating with an external host; a main storage including a first plurality of flash memory devices, wherein each memory device includes a second plurality of memory blocks, and a third plurality of first stage controllers coupled to the first plurality of flash memory devices; and a second stage controller coupled to the host interface and the third plurality of first stage controller through an internal interface, the second stage controller being configured to perform RAID operation for data recovery according to at least one parity.

Preferably, in the NVM data storage system, the first plurality of flash devices are allocated into a number of distributed channels, wherein each channel includes one of the first stage controllers and further includes a DMA and a buffer, coupled with the one first stage controller in the same channel.

Preferably, in the NVM data storage system, the controller maintains a remapping table for remapping a memory block to another memory block.

Preferably, the NVM data storage system further comprises an additional, preferably detachable, memory module which can be used as swap space, cache or confined, dedicated hot zone for frequently accessed data.

Preferably, each channel of the NVM data storage system comprises a double-buffer. The double-buffer includes two SRAM buffers which can operate simultaneously.

Also preferably, the NVM data storage system implements a second stage wear leveling function. The second wear leveling is performed across the memory modules (“globally”). The main storage is divided into a plurality of regions, and the controller performs the second stage wear leveling operation depending on an erase count associated with each region. The system maintains a second wear leveling table which includes the address translations between the logical block addresses within each region and the logical block addresses of the first stage memories.

In another aspect, the present invention discloses an NVM data storage system which comprises: a main storage including a plurality of memory modules, wherein the data storage system performs a reliability management operation on each of the plurality of memory modules individually; and a controller coupled to the main storage and configured to perform at least two kinds of RAID operations for storing data according to a first and a second RAID structure, wherein data is first stored in the main storage according to the first RAID structure, e.g., RAID-0 or RAID-1 and is reconfigurable to the second RAID structure such as RAID-4, 5 or 6.

In another aspect, the present invention discloses an NVM data storage system which comprises: a host interface for communicating with an external host; a main storage including a plurality of memory modules, wherein the data storage system performs a distributed reliability management operation on each of the plurality of memory modules individually, the reliability management operation including at least one of error correction coding, error detection coding, bad block management, wear leveling, and garbage collection; and a controller coupled to host interface and to the main storage, the controller being configured to perform RAID-4 operation for data recovery

In another aspect, the present invention discloses an NVM data storage system which comprises: data storage system comprising: a main storage including a plurality of flash devices divided into a plurality of channels; a controller configured to reduce erase/program cycles of the main storage; a memory module coupled to the controller and serving as cache memory; wherein reliability management operations including error correction coding, error detection coding, bad block management and wear leveling are performed on each channel individually.

It is to be understood that both the foregoing general description and the following detailed description are provided as examples, for illustration rather than limiting the scope of the invention.

### BRIEF DESCRIPTION OF THE DRAWINGS

The foregoing and other objects and features of the present invention will become better understood from the following descriptions, appended claims when read in connection with the accompanying drawings.

FIG. 1A illustrates a non-volatile memory data storage system with reliability management in a two stage control architecture according to the present invention. The system includes a host interface, a controller, and a main storage including multiple memory modules.

FIG. 1B shows an embodiment with distributed channels and distributed embedded reliability management.

FIG. 2 is a block diagram of the main storage 160 including regions with different capacity indexes.

FIG. 3 shows an embodiment of the present invention employing RAID-4 configuration.

FIG. 4 shows an embodiment of the present invention employing RAID-5 configuration, with a spare module.

FIG. 5 shows an embodiment with block-level repair and recovery functions.

FIG. 6 shows an embodiment with block-level repair and recovery functions, wherein a memory module reserves one or more spare blocks to repair a defected block in the same memory module. A remapping table shows the remapping information for the defected blocks.

FIG. 7 shows an embodiment of the present invention employing RAID-6 configuration, wherein a memory module reserves one or more spare blocks to repair a defected block in the same memory module.

FIG. 8 shows an embodiment of the present invention which includes a memory module which is used as a swap space or cache. The memory module can be detachable.

FIG. 9 illustrates that the cache 180 stores the random write data to reduce the Write Amplification Factor (WAF). The dual-buffer store the sequential write data and also store the data flush from the cache 180 before storing these data to the main storage 160.

FIG. 10 shows the data paths of read hit, read miss, write hit, and write miss,

FIG. 11 shows the first stage wear leveling tables.

FIG. 12 shows the address translation for segment address, logical block address ID, logical block address and physical block address; it also shows the erase/program count table for wear leveling.

FIG. 13 is a flowchart showing second stage wear leveling operation based on the segment erase count.

FIG. 14 shows a block diagram of an embodiment of the system according to the present invention, which includes BIST/BISD/BISR (Built-In-Self-Test/Diagnosis/Repair) functions.

FIG. 15 shows an embodiment of the present invention wherein down-grade or less endurable flash devices are used.

### DESCRIPTION OF THE PREFERRED EMBODIMENTS

The present invention will now be described in detail with reference to preferred embodiments thereof as illustrated in the accompanying drawings.

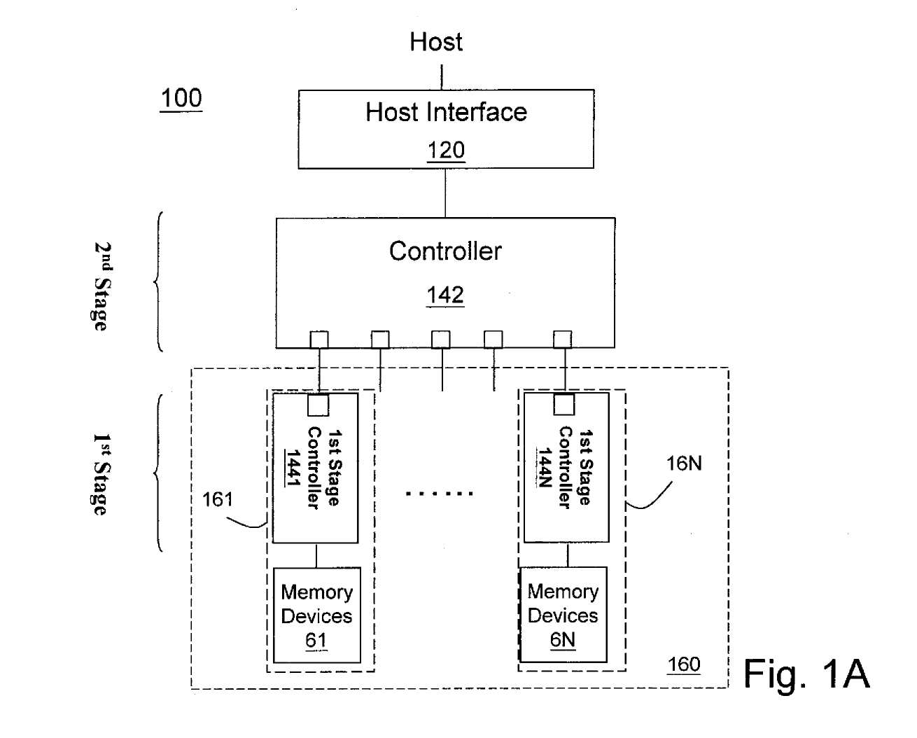

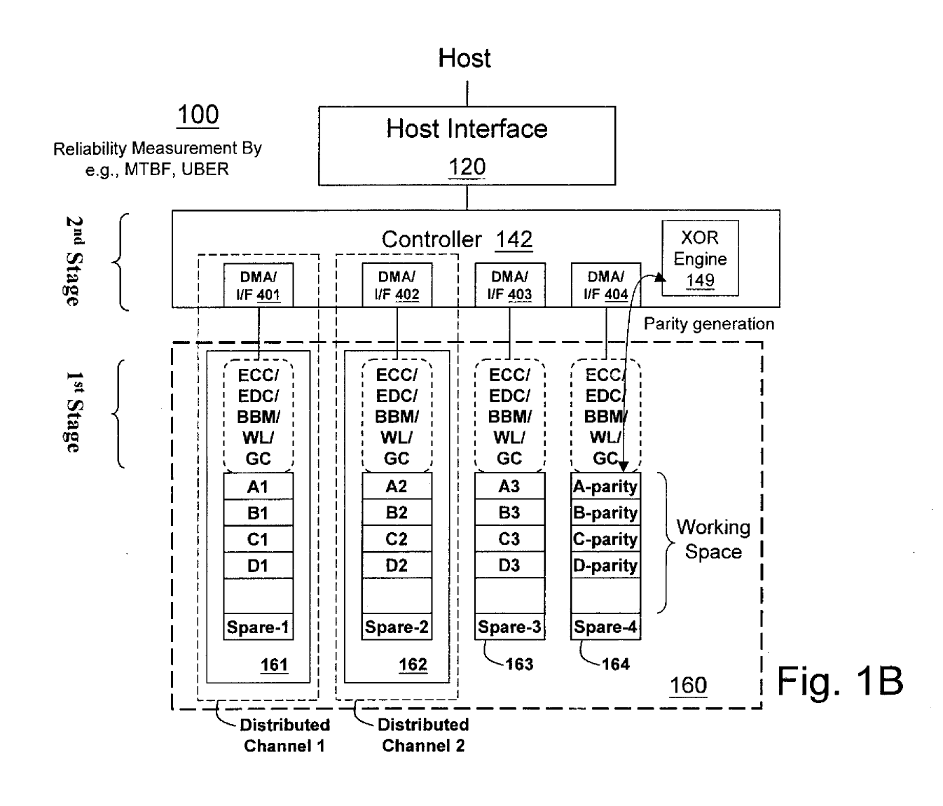

FIG. 1A shows a NVM storage system 100 according to the present invention, which employs distributed embedded reliability management in a two stage control architecture (the terms “distributed” and “embedded” will be explained later). The reliability management architecture according to the present invention provides great benefit because good reliability management will not only improve the quality of the data and prolong the lifetime of the storage system, but also increase the manufacturing yield of flash memory device chips in a semiconductor wafer, since the number of usable dies increases.

The system 100 includes a host interface 120, a controller 142 and a main storage 160. The host interface 120 is for communication between the system and a host. It can be SATA, SD, SDXC, USB, UFS, SAS, Fiber Channel, PCI, eMMC, MMC, IDE or CF interface. The controller 142 performs data read/write and reliability management operations. The controller 142 can be coupled to the main storage 160 through any interface such as NAND, LBA_NAND, BA_NAND, Flash_DIMM, ONFI NAND, Toggle-mode NAND, SATA, SD, SDXC, USB, UFS, PCI or MMC, etc. The main storage 160 includes multiple memory modules 161-16N, each including multiple memory devices 61-6N. In one embodiment, the memory devices are flash devices, which maybe SLC (Single-Level Cell), MLC (Multi-Level Cell, usually meaning 2 bits per cell), MLCₓ₃ (3 bits per cell), MLCₓ₄ (4 bits per cell) or MLCₓ₅ (5 bits per cell) memory devices. Preferably, the system 100 employs a two-stage reliability control scheme wherein each of the memory modules 161-16N is provided with a first stage controllers 1441-144N for embedded first stage reliability management, and the controller 142 performs a global second stage reliability management.

Referring to FIG. 1B, the reliability management tasks include one or more of error correction coding/error detection coding (ECC/EDC), bad block management (BBM), wear leveling (WL) and garbage collection (GC). The ECC/EDC and BBM operations are well known by one skilled in this art, and thus they are not explained here. The garbage collection operation is to erase the invalid pages and set the erased blocks free. If there is one or more valid pages residing in a to-be-erase block, such pages are reallocated to another block which has an available space and is not to be erased. The wear leveling operation reallocates data which are frequently accessed to a block which is less frequently accessed. It improves reliability characteristics including endurance, read disturbance and data retention. The reallocation of data in a block causes the flash memory cells to be re-charged or re-discharged. The threshold voltages of those re-written cells are restored to the original target levels; therefore the data retention and read disturbance characteristics are improved. Especially, because the retention quality of the MLCₓ₃, MLCₓ₄ flash devices is worse and read disturbance thereof is severer than MLCₓ₂ flash devices, WL is even more important when MLCₓ₃, MLCₓ₄ flash devices are employed in the main storage 160. According to the present invention, such reliability management operations are performed in an embedded fashion, that is, they are performed on each storage module individually, at least as a first stage reliability management. The controller 142 may perform a second stage reliability management across all or some of the storage modules.

The system 100 is defined as having “distributed” embedded reliability management architecture because it includes distributed channels, each of which is subject to embedded reliability management. In FIG. 1B, as an example, the main storage 160 includes four distributed channels (only two channels are marked for simplicity of the drawing), and each channel is provided with a memory module, i.e., the memory modules 161-164. The channels are referred as ports also. Each channel is also provided with an interface 401-404, preferably including a DMA (Direct-Memory-Access, or ADMA, i.e. Advanced-DMA) and a FIFO (not shown), in correspondence with each memory module 161-164. The ADMA can adopt a scatter-and-gather algorithm to increase transfer performance.

The controller 142 is capable of performing RAID operation, such as RAID-4 as shown in FIG. 1B, or other types of RAID operations such as RAID-0, 1, 2, 3, 5, 6, etc. (For details of RAID, please refer to the parent application U.S. Ser. No. 12/218,949.) In RAID-4 structure, the system generates a parity for each row of data stored (A-, B-, C-, and D-parity), and the parity bits are stored in the same module. Preferably, the controller 142 includes a dedicated hardware XOR engine 149 for generating such parity bits.

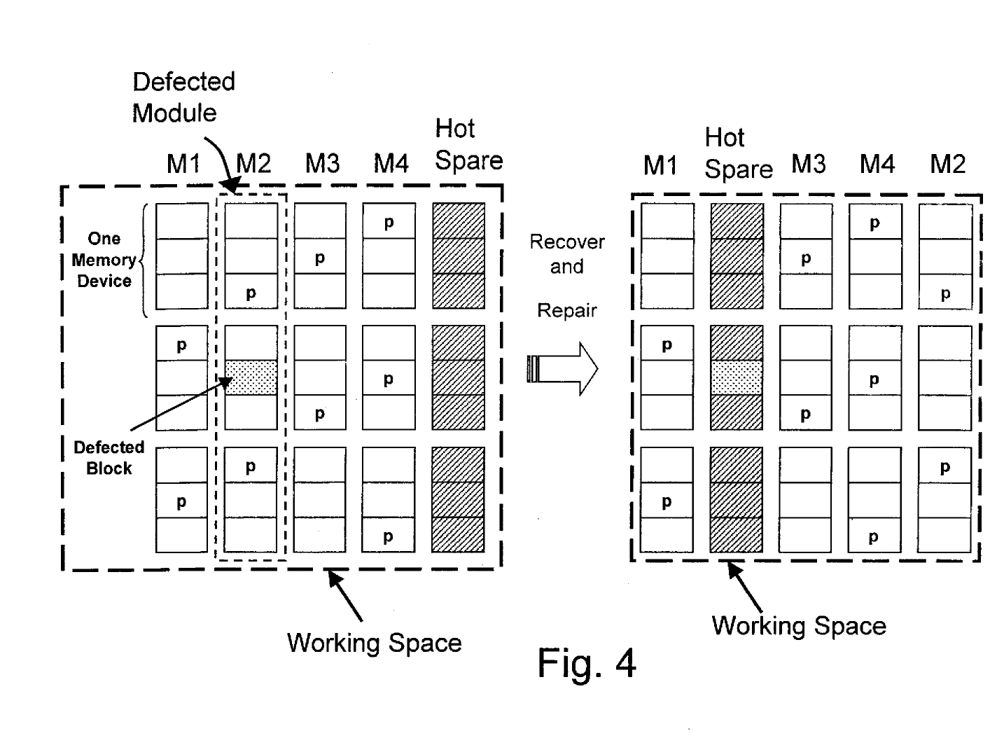

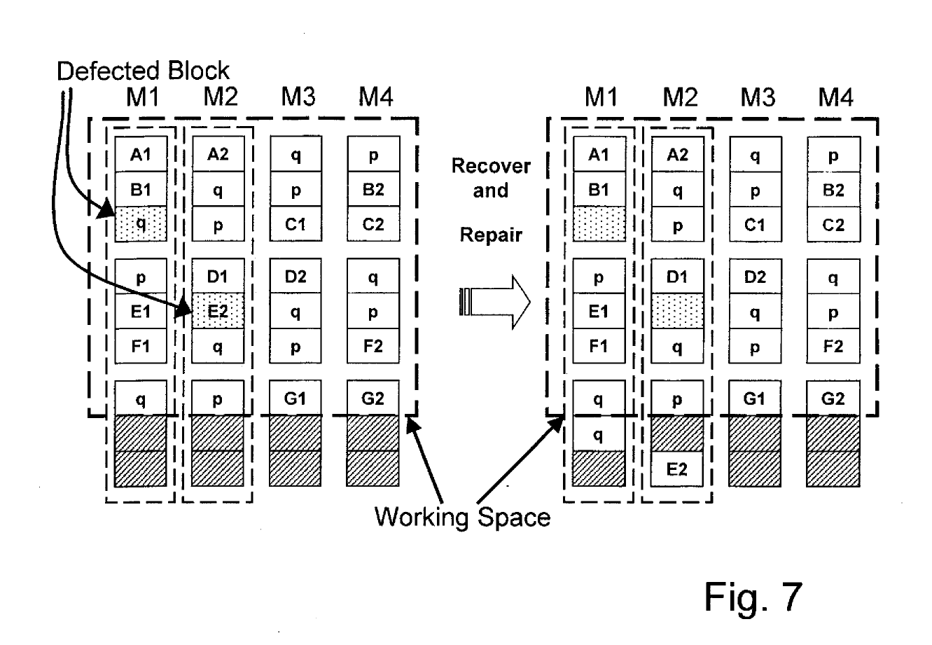

The system 100 has recovery and block repair functions, and is capable of performing remapping operations to remap data access to a new address. There are several ways to allow for data remapping, which will be further described later with reference to FIGS. 4-7. In FIG. 1B, which is one among several possible schemes in the present invention, each module 161-164 reserves at least one spare block (spare-1 to spare-4) which is not used as a working space. As long as a block in the working space is defected, the defected block will be remapped by using the spare block in the same module (spare-1 in module 161, spare-2 in module 162, etc.). The module with the defected block will be repaired and function as normal after the remapping; thus the data storage system can continue its operations after the repair. The parity blocks (A-, B-, C-, and D-parity) can be used for data recovery and rebuild. More details of this scheme will be described later in FIG. 7.

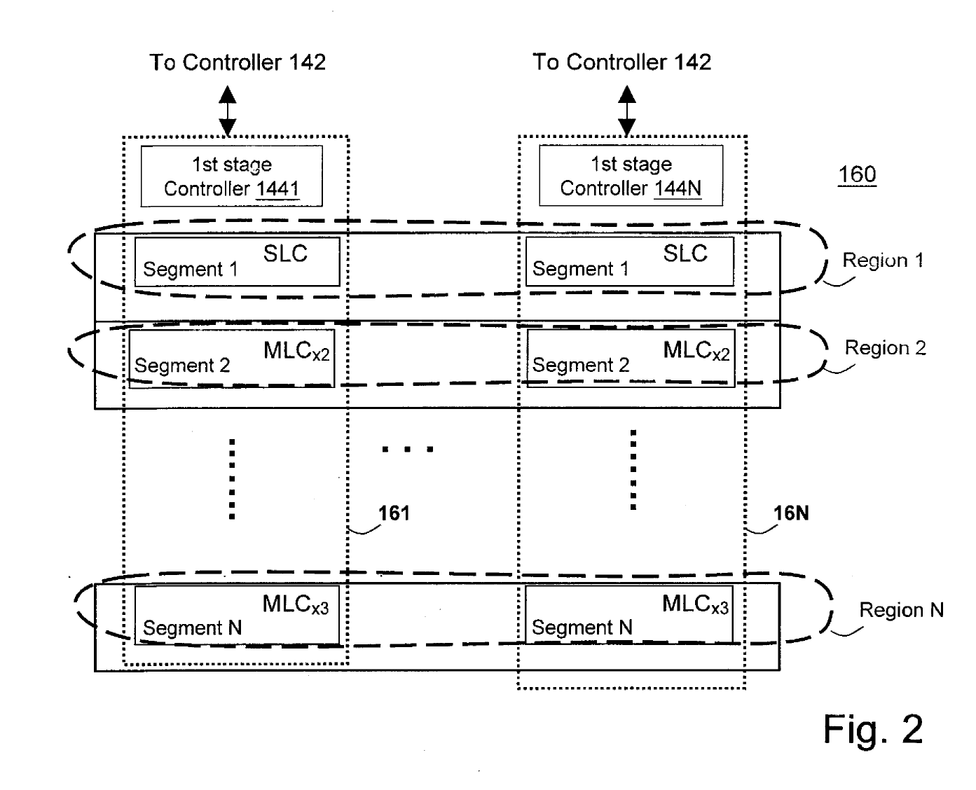

The main storage 160 can be divided into multiple regions in a way as shown in FIG. 2. Each region includes one segment in each memory module 161-16N. Each segment may include multiple blocks. In this embodiment, as shown in FIG. 2, a memory module may include memories of different types, i.e., two or more of SLC, MLC, MLCₓ₃ , MLCₓ₄ memories. It can also include down-grade memories which have less than 95% usable density. The memories with the best endurance can be grouped into one region and used for storing more frequently accessed data. For example, in this embodiment, the Region-1 includes SLC flash memories and can be used as a cache memory.

According to the present invention, a capacity index is defined for each region. Different region can have different capacity index depending on the type of flash memory employed by that region. The index is related to endurance quality of the flash devices. The endurance specification of SLC usually achieves 100 k. The endurance specification of MLCₓ₂ is 10 k, but it is 2 k for MLCₓ₃ and 500 for MLCₓ₄. Thus, for example, we can define the capacity index as 1 for MLCₓ₄, 4 for MLCₓ₃, 20 for MLCₓ₂ and 200 for SLC flash, in correspondence to their respective endurance characteristics. The capacity index is useful in wear leveling operation, especially when heterogeneous regions are employed, with different flash devices in different regions.

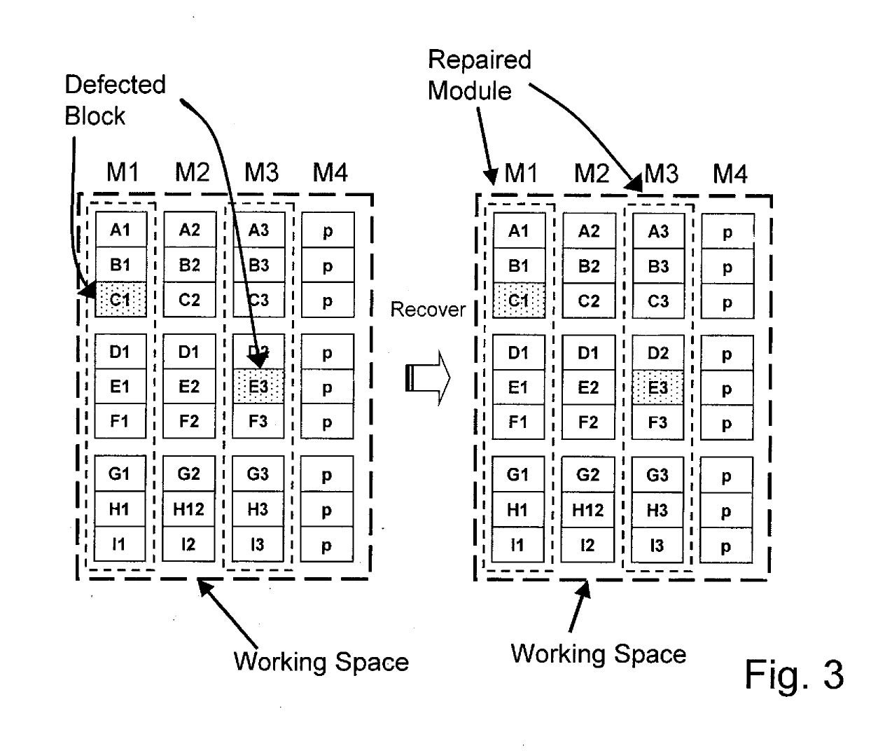

The main storage 160 is configured under RAID architecture. In one embodiment, it can be configured by RAID-4 architecture as shown in FIG. 3. In this example the main storage 160 includes four modules M1-M4. Each module includes multiple memory devices and each memory device includes multiple memory blocks (only three blocks per device is shown, but the actual block number is much more). The data are written across the modules M1-M3 by row, and each row is given a parity (p) which is stored in the module M4. Any data lost in a block (i.e., a defected block) can be recovered by the parity bits.

FIG. 4 shows another embodiment. In this embodiment, The main storage 160 is configured by RAID-5 architecture wherein the parity bits (p) are scattered to all the memory modules. In this example the main storage 160 includes four modules M1-M4 and it further includes a hot spare module. Each module includes multiple memory devices and each memory device includes multiple memory blocks (only three blocks per device is shown, but the actual block number is much more). The data are written across the modules M1-M4 by row, and each row is given a parity (p). In case a defected block is found in a module, such as M2 as shown in the left hand side of the figure, the lost data can be recovered with the help by the parity. And as the right hand side of the figure shows, the once defected module becomes a spare module after the defected module is remapped. A user may later replace the once defected module by a new module.

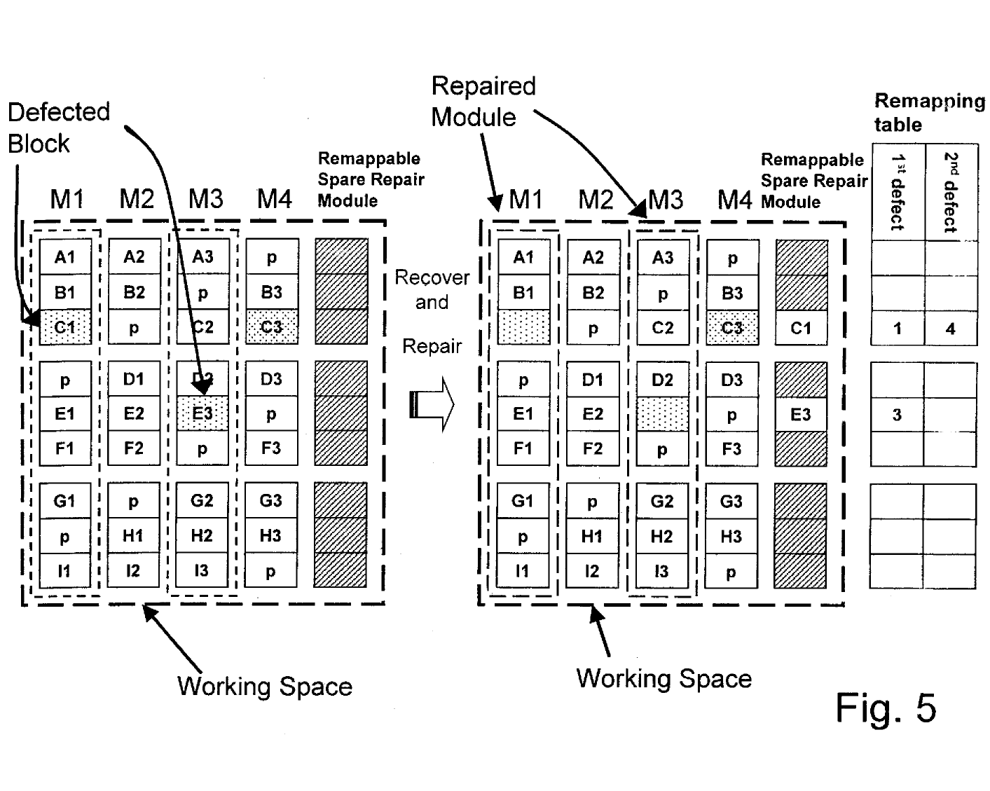

FIG. 5 shows another embodiment of the present invention, which allows block-level repair. In case one or more defected (failure) blocks are found, the spare blocks in the spare module can be used to rebuild/repair the failing blocks, including the parity blocks. The parity (p) can help to recover the lost data in the defected block. If the defected block is the parity block, the parity can be re-generated and rewritten to the spare device. The first column in the remapping table records the mapping information of the first failure block for that row. The second column records the mapping information of the second failure block for that same row. In the shown example, C1 is the first failure block in the row consisting of C1, p, C2, and C3, and E3 is the first failure block in the row consisting of E1, E2, E3, and p. Thus, the remapping table records the information such that any access to the original C1 and E3 blocks are remapped to the replacing blocks in the spare module. The scheme allows for a second failure block in the same row (such as C3), and the remapping table records it in the second column.

In the embodiments shown in FIGS. 4 and 5, the total number of spare blocks in the spare module is the same as the number of blocks in each module. However, a spare module with smaller number of spare blocks can be employed for saving costs. The above mentioned remapping information can be adjusted accordingly. In this case the number of available blocks in the spare module decides the number of rows that allow for two failure blocks.

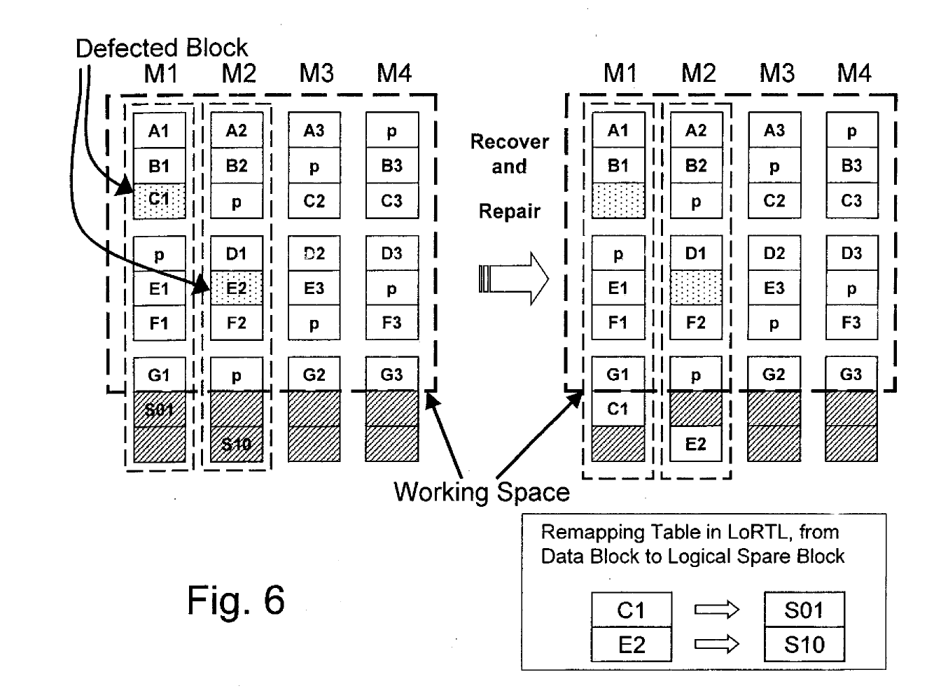

FIG. 6 shows another embodiment of the present invention. In this embodiment, each module reserves one or more spare blocks which can be used to repair or replace the failure blocks in the same module. No spare module is required (although it can certainly be provided) in this embodiment. Note that although the spare blocks are shown to be logically located in one area wherein they are all close together, they do not have to be physically close to each other. An address mapping table for each module is created at controller 142, referred to as the “Logical RAID Translation Layer™ (LoRTL™)” which can be stored in an embedded SRAM in the controller 142 for faster execution speed during operation. The capacity of spare blocks in each memory module may be calculated by subtracting the RAID working volume from all available capacity. Usually spare blocks only need about 1%˜3% of the overall capacity. The spare blocks can be used to rebuild and recover the failure blocks out of any errors, such as the errors of reading the flash cells which can not be recovered by using ECC/EDC mechanism. The controller 142 is able to recognize those errors through vendor command from the memory modules.

To rebuild the lost data in the defected block (for example, C1 in the left side of the figure), the following steps may be performed:
(a) Read C2, C3 and Parity (p in M2, 3^{rd} row).
(b) C2 XOR C3 XOR Parity→Original-C1.
(c) Write Original-C1 to S01 location.
   The address mapping table will add an entry to show C1 mapping to S01. Similarly, the lost data in the other defected block can be recovered.

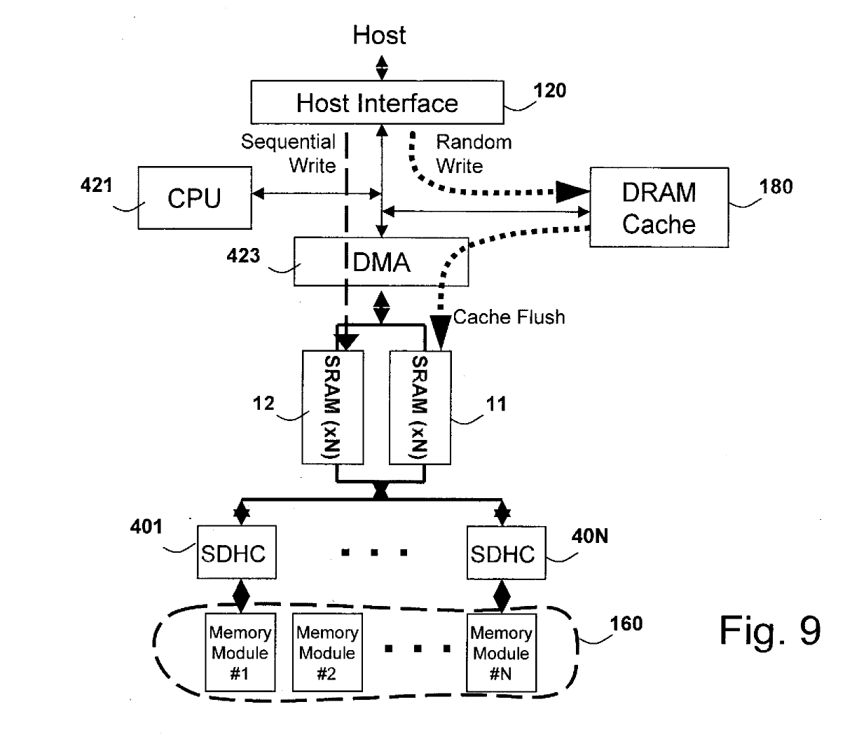

FIG. 7 shows another embodiment of the present invention, which employs RAID-6 configuration with dual parity (p and q). RAID-6 allows for three failure blocks in the same row, so it renders better reliability but with higher costs due to extra parity blocks. Under RAID 6 configuration, similar to the embodiment of FIG. 6, a module can reserve spare blocks to replace or repair the failure blocks residing in the same module, as shown in FIG. 9. As described with reference to FIG. 1B, an XOR engine can be employed in RAID-4/5/6 configuration for parity generation and data rebuild. All the above embodiments can greatly improve MTBF and UBER values. Note that in the embodiments shown in FIGS. 4-7, where a defected block requires to be repaired by a spare block either in the same module or in a spare module, the controller 142 maintains a remapping table for remapping the defected memory block to the replacing memory block.

According to the present invention, in another embodiment, the system 100 is a reconfigurable RAID system. To this end, the controller 142 is configured so that it is capable of performing two kinds of RAID operations, such as RAID-0/1 and RAID-4/5/6. At first, the data is stored in the main storage 160 by, e.g., RAID-0 or RAID-1. After a reliability threshold is reached, the controller 142 is triggered to reconfigure the data to another RAID structure such as RAID-4, 5 or 6. Before reconfiguring the data to the second RAID structure, the controller 142 may send out a notice to a user, so that the user can decide whether to initiate such reconfiguration. The reliability threshold may be a time-based value such as a value relating to the real time or the operating time of the system, or it may be a value relating to the memory access count, such as the erase count, program count, or read count in the form of a total, an average, or a maximum count number of some or all of the memory blocks/devices/modules.

Preferably, the system includes one or plural read counters and one or plural erase counters. In one embodiment, the read counter may operate as follows:
(1) The read counter will be incremented based on the number of page reads within the block.
(2) Once the block is erased, the read counter for that block is reset.
(3) If the old data in that page is updated, the block will be erased later, so the read counter for this new data in the specific page is reset.

In one embodiment, with the erase counter, the system 100 may perform a second-stage reliability management as follows, which is even more beneficial if there is no wear leveling implemented in the first-stage:
(1) If a new data is written to an old data within a block, the block will be erased once through garbage collection in the first-stage reliability management (within the memory module).
(2) If an old data within a block is deleted, this block will be erased once if it is known that the block is erased both in FAT (File Allocation Table) and in the memory module, and the location of the erased block can be tracked.

The above mentioned algorithm is based on the condition that there is certain garbage collection mechanism implemented in the first-stage (within the memory module).

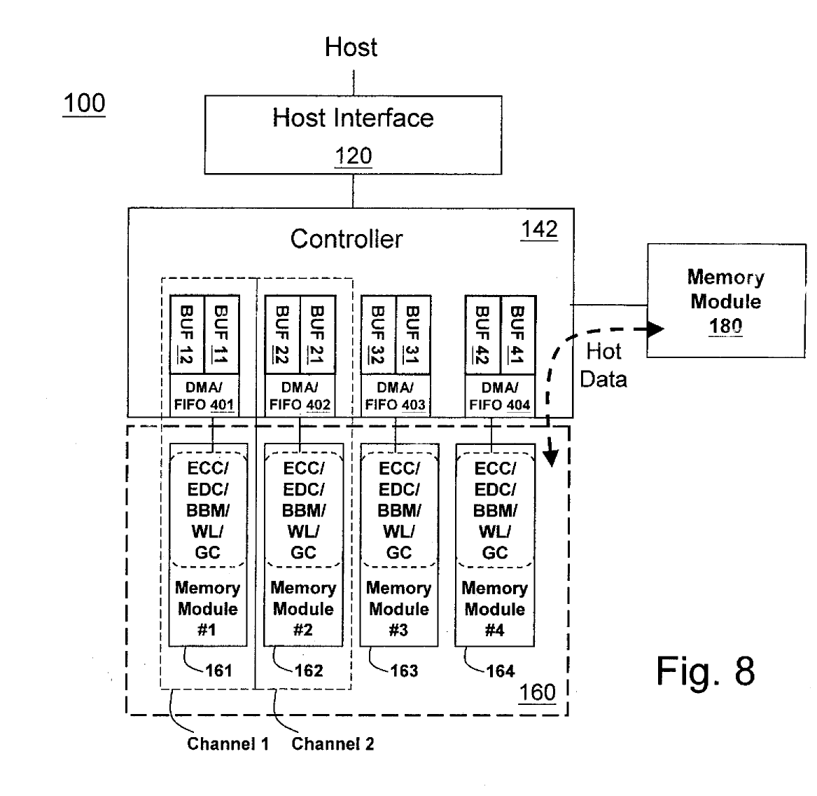

To further improve the reliability of the data storage system 100, a memory module 180 serving as a swap space or as a cache memory is coupled to the controller 142 as shown in FIG. 8. The memory module can serve as a confined, dedicated hot zone for frequently accessed data (or called “hot data”). The memory module 180 serves to reduce the write (also referred to as “program”) and erase cycle in the main storage 160, such that it prolongs the lifetime of the main storage 160. Preferably, abetter quality or endurance memory, such as SLC flash, NOR flash, SRAM or DRAM is used as the memory module 180 so that the memory module 180 does not wear out earlier than the main storage 160. In one embodiment, the memory module 180 is detachable, such that the memory module 180 can be unplugged from the system 100 or replaced by a new memory module in case of failure or for memory expansion.

Each distributed channel may include distributed double buffers (11, 12, 21, 22, 31, 32, 41 and 42). FIG. 9 shows more details of such double-buffer architecture. In this embodiment, the buffers 11 and 12 are SRAM and the memory module 180 is a DRAM serving as a cache, but they can be made of other types of memories. The system preferably uses SDHC (Secure Digital High Capacity) protocol as internal interface. The controller 142 includes a CPU (Central Processor Unit) 421 and a DMA (Direct Memory Access) 423. The two SRAM buffers 11 and 12 can operate simultaneously; for example, when one SRAM buffer is receiving data, the other SRAM buffer can transmit data at the same time. As another example, when one of the SRAM buffers is full of data, the other SRAM buffer can start to receive data in parallel. The double-buffer scheme improves the write and read performance of the channels as well as the overall storage system 10. The DRAM cache 180 stores the random write data to reduce the Write Amplification Factor (WAF). The SRAM buffers 11 and 12 (either or both) store the sequential write data and also store the data flush from the DRAM cache 180 before storing these data to main storage 160. In another embodiment, the double-buffer is made into a single buffer to simplify the hardware implementation and save cost.

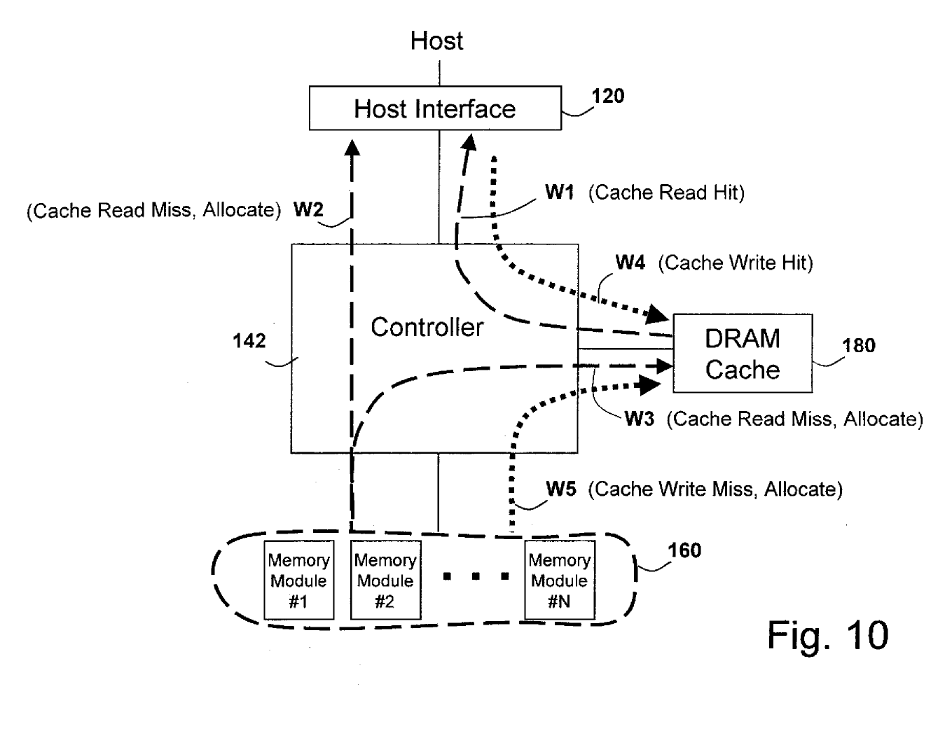

FIG. 10 shows the data paths for cache read and cache write. In a read operation, if a corresponding data is found in the cache 180 (cache read hit), then the data is read from the cache 180 as shown by the arrow W1. If a corresponding data is not found in the cache 180 (cache read miss), then read the missed data from the main storage 160 both to the host (arrow W2) and to the cache 180 (arrow W3), which is called “read allocate”. In a write operation, if a corresponding data (in write operation the corresponding data is a prior version of the present data to be written) is found in the cache 180 (cache write hit), then the data is written into the cache 180 as shown by the arrow W4. If a corresponding data is not found in the cache 180 (cache write miss), then the system reads missed data from the main storage 160 to the cache 180, i.e. write allocate, before writing missed data to the cache 180. The memory module 180 can further include a buffer RAM, such as SRAM, mobile DRAM, SDRAM, DDR2, DDR3 DRAM or low power DRAM.

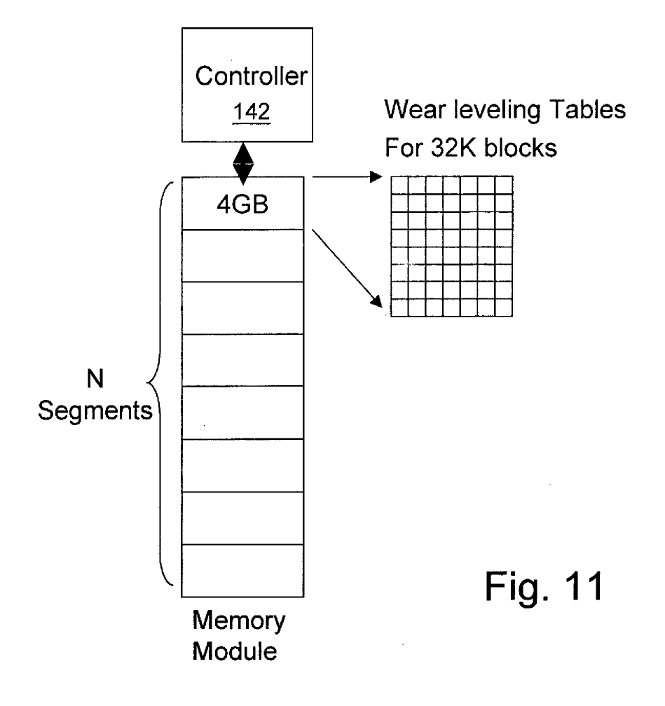

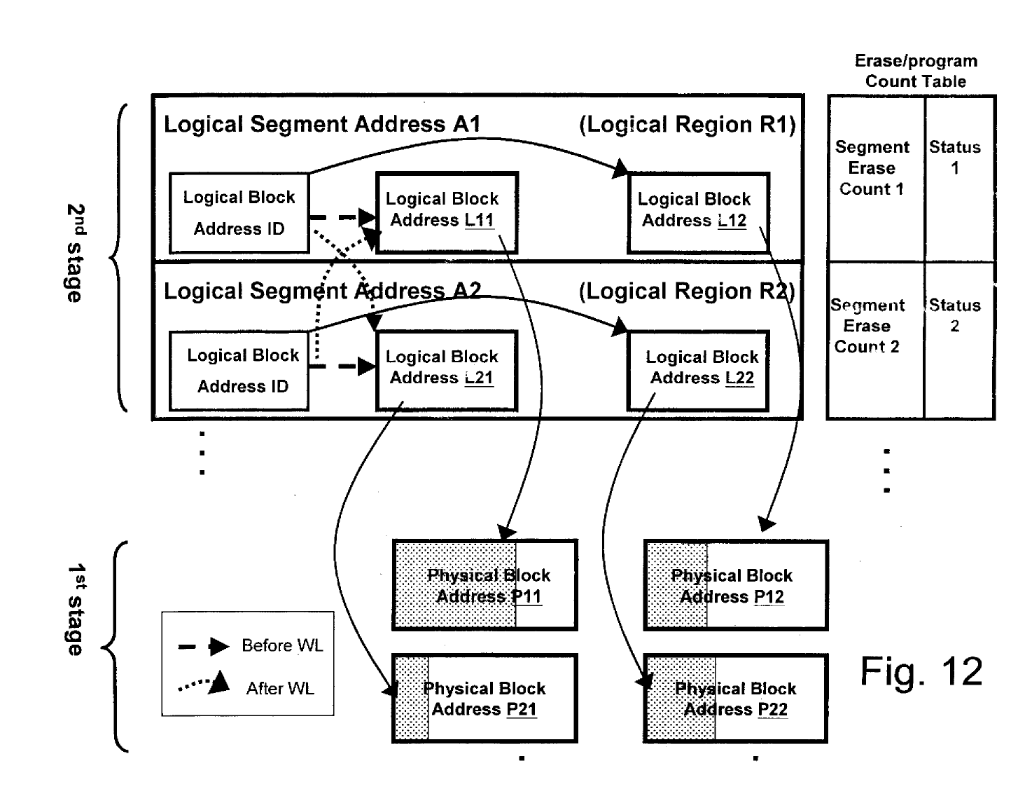

In a preferred arrangement according to the present invention, the system 100 performs two-stage reliability management. The first stage reliability management is performed for an individual memory module, while the second stage reliability management is performed across the whole main storage 160 (global reliability management). FIG. 11 shows the first stage wear leveling tables and FIG. 12 shows the collaboration between the first stage and the second stage. Referring to FIGS. 1 and 11, each memory module 161-16N in FIG. 1 is divided into a plurality of blocks. The memory module is also divided into N segments. Assuming that each block has a density of 1 Mb, then there are 32,000 blocks for each 4 G-Byte segment. The wear leveling tables include the translation between local logical block addresses and physical block addresses. Each segment has its own wear leveling table which may be saved in a specified area in the memory module. Each entry in the table represents the journal of one block, namely the erase or write cycle information of the block.

Referring to FIG. 12, each of the logical regions (R1 and R2) includes multiple segments, one in each memory module of the main storage 160, but only one segment (logical segment address A1 or A2) is shown for each logical region. The global wear leveling table includes the translation between the logical block addresses within each segment and the logical block addresses of the first stage memory blocks. Before a wear leveling operation is performed, the global wear leveling table shows that in the logical region R1, two block addresses map to the logical block addresses L11 and L12, and in the logical region R2, two block addresses map to the logical block addresses L21 and L22, respectively. In physical layer, the logical block addresses L11 and L12 correspond to the physical block addresses P11 and P12 in the first stage memory blocks, and the logical block addresses L21 and L22 correspond to the physical block addresses P21 and P22, respectively. In this example, it is found that the physical block address P11 is used much more often than the physical block address P21. (Background dotted blocks show wear information.) Therefore, a wear leveling operation is performed, to remap the original logical block addresses L21 to L21, and vise-versa, which is a “swap”. As such, the data originally stored in the physical block address P11 and the physical block address P21 are interchanged after wear leveling operation.

The second stage wear leveling requires the wear information of the first stage so that they may be “synchronized” with each other. The synchronization of the first stage wear leveling and the second stage wear leveling (or other types of reliability management) can be done by a simple command, for example by issuing an SD (Secure Digital) Command and SD Response in case the memory modules are SD cards. In terms of the second stage wear leveling, the wear leveling between regions can be performed based on, e.g., the erase or program count in each region. For this purpose, the wear leveling table can include an erase or program count table as shown in the right hand of FIG. 12. The address translation table can be created in LoRTL™.

A segment erase count can be determined by various ways. The segment erase count can be an average erase count or a total erase count of all the blocks inside that segment, if wear leveling operation is performed in the first stage. The segment erase count can be the erase count of the most frequently erased block, if no wear leveling operation is performed in the first stage. In a preferred embodiment, each region is provided with one segment erase count to simplify the wear leveling table and to reduce the number of entries to the wear leveling table. This reduces the memory size required to store the wear leveling table.

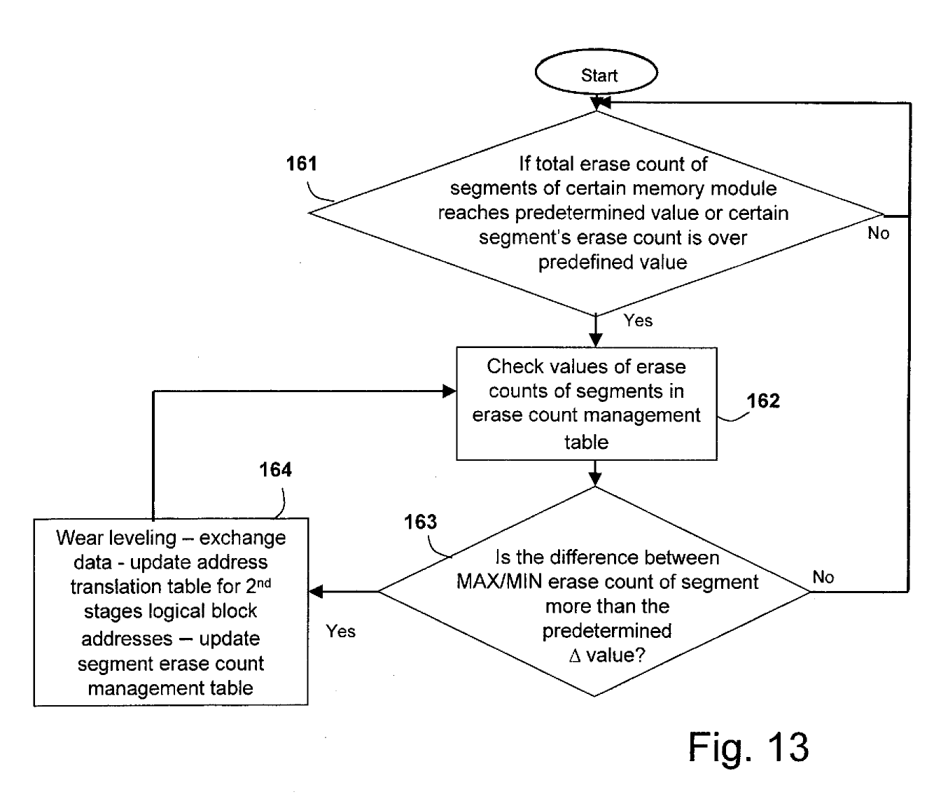

FIG. 13 is a flowchart showing second stage wear leveling operation based on the segment erase count. It is important to balance out the wearing of the most frequently erased block with the less erased block, especially in the case where no wear leveling is performed in the first stage. Referring to FIG. 13, instep 161, the system 100 checks whether the total erase count of segments of a certain memory module reaches a predetermined value, or a certain segment's erase count is over a predefined value. If yes, it goes to the step 162 wherein the system 100 checks the erase counts of all the segments in that memory module; such information for example is stored in an erase count management table. Next in step 163, the system 100 checks whether the difference between a maximum segment erase count and a minimum segment erase count is more than a predetermined Δ value? If not, it goes back to the step 161. If yes, the system 100 performs global wear leveling, including exchanging data between the most frequently erased block and the less erased block, updating address translation table for second stages logical block addresses, and updating segment erase count management table, etc.

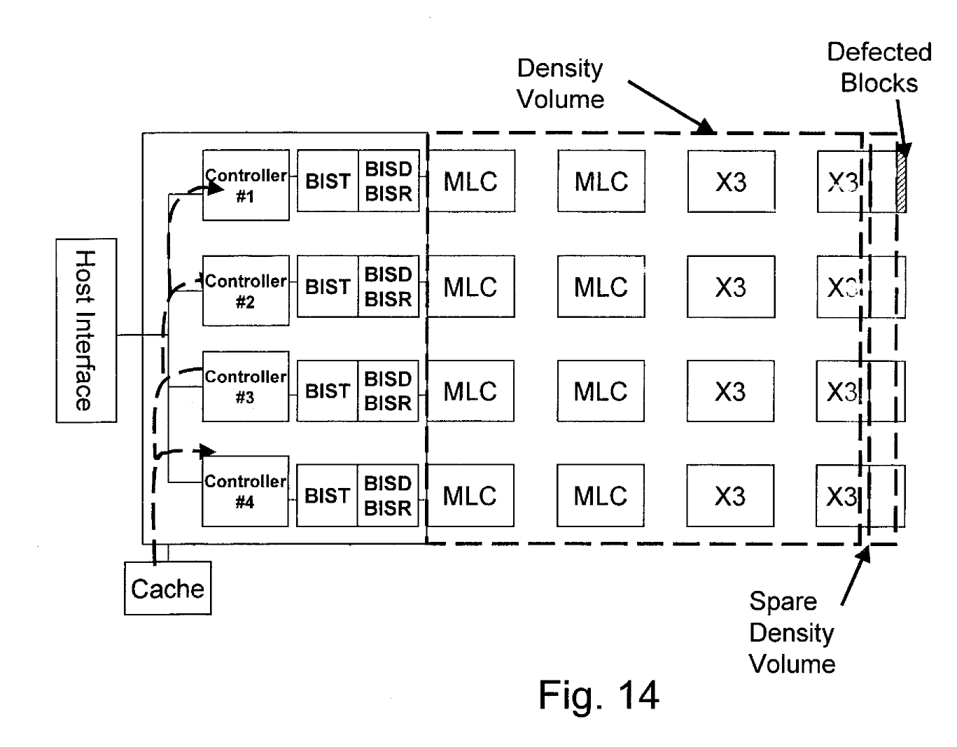

FIG. 14 shows a block diagram of BIST/BISD/BISR (Built-In-Self-Test/Diagnosis/Repair). In on embodiment, the system includes two stage BISD (i.e., the BISD operations are performed in the above mentioned two-stage control architecture), which can detect and diagnose the defected flash devices on-the-fly by using ECC/EDC to check flash memory array including spare blocks area before flash devices fail. The BISD circuit can detect if flash devices become less than the needed density due to too many bad blocks. The BISR can repair the defected flash device on-the-fly by using advanced Bad Block Management or by by-passing the defected blocks. The BISR scheme can do on-the-fly repair by re-distributing the data.

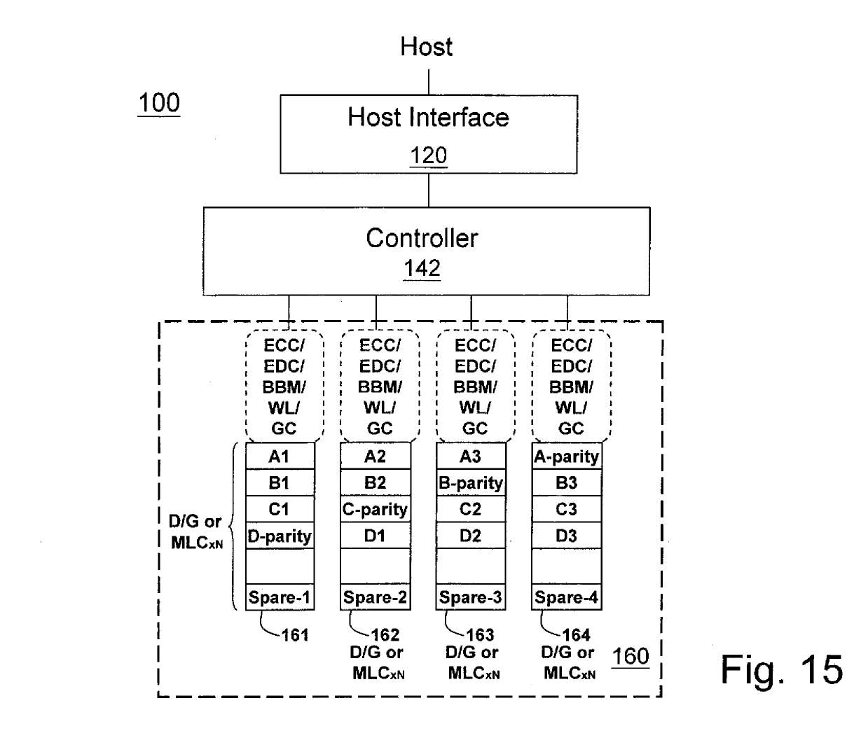

Referring to FIG. 15, because the system 100 according to the present invention has great reliability management capabilities, the memory modules 161-164 in the main storage 160 area can employ down-grade (D/G) flash devices or MLC_{xN} flash devices, wherein N=2, 3, 4 or 5. Such flash devices usually have inferior reliability quality to that of SLC flash devices, but they can be properly managed in the system of the present invention.

The present invention has been described in detail with reference to certain preferred embodiments and the description is for illustrative purpose, and not for limiting the scope of the invention. One skilled in the art can readily think of many modifications and variations in light of the teaching by the present invention. In view of the foregoing, all such modifications and variations should be interpreted to fall within the scope of the following claims and their equivalents.

What is claimed is:

1. A non-volatile memory data storage system with two-stage controller, comprising:
a host interface for communicating with an external host;
a main storage including
a first plurality of flash memory devices, wherein each memory device includes a second plurality of memory blocks; and
a third plurality of first stage controllers coupled to the first plurality of flash memory devices; and
a second stage controller coupled to the host interface and the third plurality of first stage controller through an internal interface, the second stage controller being configured to perform RAID operation for data recovery according to at least one parity.

2. The data storage system of claim 1, wherein the first plurality of flash devices are allocated into a number of distributed channels, wherein each channel includes the flash devices allocated into the channel and one of the first stage controllers, and further includes a DMA (Direct Memory Access) and a buffer, coupled with the one first stage controller in the same channel.

3. The data storage system of claim 2, wherein the buffer in each channel is a double-buffer including two memory buffers which are capable of operating simultaneously.

4. The data storage system of claim 1, wherein the controller maintains a remapping table for remapping a memory block to another memory block.

5. The data storage system of claim 4, wherein the remapping table includes translation between logical block addresses and physical block addresses.

6. The data storage system of claim 4, wherein each channel reserves at least one memory block as a spare block, and wherein the remapping table remaps a memory block to the spare memory block of the same channel.

7. The data storage system of claim 4, further comprising a spare memory module, and wherein the remapping table remaps a memory block to a memory block in the spare memory module.

8. The data storage system of claim 1, wherein the host interface being one of SATA, SD, SDXC, USB, SAS, Fiber Channel, PCI, eMMC, MMC, IDE and CF interface.

9. The data storage system of claim 1, wherein the flash memory devices include at least one selected from down-grade flash device and MLC_{xN} flash device, wherein N=2, 3, 4 or 5.

10. The data storage system of claim 1, wherein the memory devices are allocated into a plurality of regions, each region including a plurality of memory blocks of each one of the channels, and at least one of the plurality of regions including SLC flash memory devices and this one region being used as a cache memory.

11. The data storage system of claim 1, wherein the controller is configured to perform RAID-4, RAID-5 or RAID-6 operation.

12. The data storage system of claim 1, wherein the controller further comprises an XOR engine to generate the parity.

13. The data storage system of claim 1, further comprising an additional memory module coupled to the controller for more frequent access than the main storage, wherein the additional memory module is a DRAM, SRAM, SLC flash or NOR flash.

14. The data storage system of claim 13, wherein the additional memory module is detachable.

15. The data storage system of claim 13, wherein the additional memory module serves as a cache, and wherein the controller performs the following operations:
in a read operation, if a data to be read is in the cache, read it from the cache, and if a data to be read is not in the cache, read it from the main storage and write it to the cache;
in a write operation, if a data to be written has a prior version in the cache, write it to the cache, and if a data to be written does not have a prior version in the cache, read the prior version from the main storage and write the prior version to the cache before writing the data.

16. The data storage system of claim 1, wherein the controller further performs a second stage wear leveling operation across different channels.

17. The data storage system of claim 16, wherein the memory devices are allocated into a plurality of regions, and the controller performing a second stage wear leveling operation depending on an erase count or program count associated with each region.

18. The data storage system of claim 1, wherein the second-stage controller performs reliability management operation including at least one of error correction coding, error detection coding, bad block management, wear leveling, and garbage collection.

19. The data storage system of claim 1, further comprising:
a two-stage BISD circuit which detects and diagnoses the memory devices on-the-fly; and
a two-stage BISR circuit which repairs a memory device which is defected on-the-fly by bad block management.

20. The data storage system of claim 1, wherein the internal interface includes one selected from a standard NAND, LBA_NAND, BA_NAND, Flash_DIMM, ONFI NAND, Toggle-mode NAND, SATA, SD, SDXC, USB, UFS, PCI and MMC interface.

21. A non-volatile memory data storage system, comprising:
a main storage including a plurality of memory modules, wherein the data storage system performs a reliability management operation on each of the plurality of memory modules individually, the reliability management operation including at least one of error correction coding, error detection coding, bad block management, wear leveling, and garbage collection; and
a controller coupled to the main storage and configured to perform at least two kinds of RAID operations for storing data according to a first and a second RAID structure, wherein data is first stored in the main storage according to the first RAID structure and is reconfigurable to the second RAID structure; wherein the controller reconfigures the data to the second RAID structure, or sends out a notice to reconfigure the data to the second RAID structure, according to a pre-defined reliability threshold which relates to time, erase count, program count or read count.

22. A non-volatile memory data storage system comprising:
a host interface for communicating with an external host;
a main storage including a plurality of flash devices divided into a plurality of channels;
a controller coupled to the host interface and configured to reduce erase/program cycles of the main storage;
a memory module coupled to the controller and serving as cache memory or serving as a swap space;
wherein reliability management operations including error correction coding, error detection coding, bad block management and wear leveling are performed on each channel individually.

23. A non-volatile memory data storage system, comprising:
a host interface for communicating with an external host;
a plurality of distributed channels each including
a flash memory device;
a buffer; and
a DMA (Direct Memory Access) coupled to the buffer; and
a controller coupled to the host interface and the plurality of distributed channels.
